(19) United States
(12) Patent Application Publication
(10) Pub. No.: US 2024/0111555 A1
(43) Pub. Date: Apr. 4, 2024

(54) UNKNOWN OBJECT SUB-CLASS IDENTIFICATION

(71) Applicant: International Business Machines Corporation, Armonk, NY (US)

(72) Inventor: Vijay Sundaresan, Markham (CA)

(21) Appl. No.: 17/960,022

(22) Filed: Oct. 4, 2022

(51) Int. Cl. G06F 9/455; G06F 9/30; G06F 11/36

(52) U.S. Cl. CPC G06F 9/4552; G06F 9/30076; G06F 11/3684

(57) ABSTRACT

The present specification describes a computer-implemented method. A first comparison test is executed to determine whether an unknown object is of a first sub-class of a class of objects. Responsive to determining that the unknown object is not of the first sub-class, it is determined whether the unknown object is an instance of a second sub-class by determining whether there are additional sub-classes other than the first sub-class and a second sub-class. Responsive to determining that there are additional sub-classes, the second code fragment executes while refraining from assuming the unknown object is of a particular sub-class.

### BACKGROUND

The present invention relates to identifying sub-classes of an unknown object in a program instruction set, and more specifically, to identifying the unknown object when there are two or more sub-classes associated with an identified class of the object, which identification prevents a second comparison test from being executed.

### SUMMARY

According to an embodiment of the present invention, a computer-implemented method is described. According to the computer-implemented method, a processor executes a first comparison test to determine whether an unknown object is an instance of a first sub-class of a class of objects. Responsive to the processor determining that the unknown object is not an instance of the first sub-class, the processor prevents a second comparison test by determining whether the unknown object is an instance of a second sub-class by determining whether there are additional sub-classes of the class of objects other than the first sub-class and a second sub-class. Responsive to determining that there are no additional sub-classes, the processor executes a second code fragment which assumes the unknown object is an instance of the second sub-class.

The present specification also describes a system that includes a processor and a memory device communicatively coupled to the processor. The memory device includes instructions executable by the processor. The instructions include instructions to execute a first comparison test to determine whether an unknown object is an instance of a first sub-class of a class of objects. The memory device also includes instructions to, responsive to determining that the unknown object is not an instance of the first sub-class, prevent a second comparison test by performing a no operation (NOP) test to determine whether there are additional sub-classes of the class of objects other than the first sub-class and a second sub-class. The memory device also includes instructions that, responsive to determining that there are no additional sub-classes, execute a second code fragment which assumes the unknown object is an instance of the second sub-class.

The present specification also describes a computer program product. The computer program product includes a computer readable storage medium having program instructions embodied therewith. The program instructions are executable by a processor and cause the processor to execute a first comparison test to determine whether an unknown object is an instance of a first sub-class of a class of objects. Responsive to a determination that the unknown object is not an instance of the first sub-class, the program instructions are executable by the processor to prevent a second comparison test by performing a no operation (NOP) test to determine whether there are additional sub-classes for the class of objects other than the first sub-class and a second sub-class. Responsive to a determination that there are no additional sub-classes, the program instructions are executable by the processor to execute a second code fragment which assumes the unknown object is an instance of the second sub-class.

### BRIEF DESCRIPTION OF THE DRAWINGS

FIG. 1 depicts a computing environment for the execution of unknown object sub-class identification, according to an example of the principles described herein.

FIG. 2 depicts a computer-implemented method for identifying unknown object sub-classes, according to an example of the principles described herein.

FIG. 3 depicts a computer-implemented method for identifying unknown object sub-classes, according to an example of the principles described herein.

FIG. 4 depicts a system for identifying unknown object sub-classes, according to an example of the principles described herein.

FIG. 5 depicts a computer program product with a computer readable storage medium for identifying unknown object sub-classes, according to an example of the principles described herein.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing devices such as desktop computers, laptop computers, all-in-one devices and the like execute instruction sets to perform intended operations. That is, to execute the millions of operations it is capable of performing, a computing device is fed instruction sets that are in a computing language that the hardware components of a computing device can understand and interpret to perform an intended operation. As a particular example, a word processing application may print a text document by executing printing instruction sets. Before the instruction set is executed, it is constructed or compiled. Compilation of an instruction set refers to the operation where human readable source code generated by a user is converted into machine code executable by a processor of the computing device. During compilation, files that include the instruction set are evaluated for validity or “de-bugged.” There are various forms in which instruction sets are compiled. For example, with a static language the file is compiled before runtime execution. By comparison, with a dynamic language the compilation is performed during runtime execution. One particularly relevant feature of a dynamic language is that the “type” of a variable, which is a component of the instruction set, is not identified until runtime execution. That is, with a static language the type, or class, of an object is identified before the instruction set is executed. By comparison, with a dynamic language, object classes, or sub-classes, are determined during runtime execution.

As one specific example, a Java virtual machine (JVM) is a language environment for executing Java instruction sets. The source code is stored in a .class file which the JVM receives and executes. As discussed above, when executing a dynamic language, object types are determined at runtime, rather than via a pre-runtime compiler. There may be an overhead associated with executing dynamic language instruction sets to test the class of an object as there is a possibility of classes being loaded/sub-classed at any time. There are multiple ways that the JVM can determine the type of a particular unknown object. As a first example, the JVM may run an “instanceof” test which appears in the application (i.e., Java) source code. An example is provided below.

if (x instance of A)
{
... code fragment C1 that assumes x is an instance of A
}
else
{
...code fragment C2 that does not assume any sub-class for x
}

In another example, the type test may be added by a just-in-time (JIT) compiler for guarding inlined or devirtualized code paths. An example is provided below.

if (x.class == A)
{
... inlined code C3 for A.foo that assumes x is an instance of A
}
else
{
...virtual call x.foo
}

In these examples, x is a variable in a program, X is a declared class type of the variable x. A is a first non-abstract sub-class of X that is loaded by the JVM when the program is run, and B is a second non-abstract sub-class of X that is loaded by the JVM when the program is run. foo is a virtual method that is declared in class X and therefore should be valid to call on variables (e.g., x) declared to be of class type X (run time type could be X, A, or B). That is, a virtual call is a feature of object-oriented language which makes a call on the object without knowing the runtime type of object.

Still further in this example, C1 is a code fragment (that is either written by the user in the program or created by the JIT compiler due to an optimization such as inlining) executed if x is known to be of sub-class type A in the original code. Similarly, C2 is a code fragment (that is either written by the user in the program or created by the JIT compiler due to an optimization such as inlining) executed if x is known to be of sub-class type B in the original code. C3 is similarly a code fragment that assumes a sub-class type for x. As a practical example, X may be the class “vehicle” while A is the sub-class “car” and B is the sub-class “truck.” In this example, foo may be a virtual method “drive,” which is valid to call the method “drive” so long as x is of the class type “vehicle.” Based on whether the runtime-determined sub-class of x is A, e.g., “car” or B, e.g., “truck,” different “drive” methods get called that implement the driving functionality for a “car” variable or a “truck” variable.

In either example, the JVM is performing a comparison test (e.g., an “instanceof” test or a type test added by a JIT compiler) which is a set of instructions to do a comparison. For example, the type test added by a JIT compiler of “if x.class=B” would result in a compare instruction followed by a conditional branch instruction.

Dynamic compilers have access to information that a static compiler would not, due to the program having already run for a time. That is, the dynamic compiler may be aware of which classes have been loaded and invoked during execution and may thus tailor its optimization accordingly. For example, a JIT compiler may pick which one of A or B is more frequently encountered class and may inline the more frequently executed method first and the less frequently executed method second.

Other benefits include knowing which code paths are executed more frequently and ordering those code paths to be adjacent to each other. JIT compilers may also facilitate platform exploitation and hardware exploitation that use information regarding the platform and hardware components of the computing device to optimize code execution.

Due to the removal of a pre-runtime compilation, the dynamic language and JIT compilers provide for a reduced development time. Further developments may be made to the above code sections to further increase the efficiency of the underlying code. For example, if there is a single concrete sub-class A in the class hierarchy rooted at X, then the JIT compiler can optimize these type tests by performing a no operation (NOP) test. By executing a NOP test, the JVM may skip performing the comparison test explicitly to determine the sub-class of x. Instead, the JVM may rely on a runtime assumption that gets registered with the JIT compiler to preserve functional correctness. In other words, as long as there is a single concrete sub-class A loaded in the class hierarchy rooted at X, comparison testing can be avoided since there is just one possible sub-class (e.g., A) that x can be an instance of. If a new sub-class B in the class hierarchy rooted at X gets loaded after the compiled code gets generated, then the compiled code would get patched to preserve functional correctness even though this would come at a performance cost. Revised versions of the example code are provided below with the patches described. Referring to the first example, the patched code may be:

if (NOPed test that A is the only concrete sub-class in hierarchy rooted at
X)
{
... code fragment C1 that assumes x is an instance of A
}
else
{
if (x instance A)
}
... code fragment C1 that assumes x is an instance of A
}
else
{
...code fragment C2 that does not assume any sub-class for x
}

For the second example, the patched code may be:

if (NOPed test that A is the only concrete sub-class in hierarchy rooted at
X)
{
... inlined code C3 for A.foo that assumes x is an instance of A
}
else
{
...virtual call x.foo
}

Note however, that implementing the NOP test may not be possible in circumstances in which there are more than one concrete sub-classes (e.g., A and B) in the class hierarchy at X at the time when compiled code is generated. Accordingly, the present disclosure describes a method, system, and computer program product that increase the efficiency of the JIT compiler when there are two concrete sub-classes (e.g., A and B) in the class hierarchy rooted at X at the time the source code is generated. In general, there is a sequence with a single comparison test and a single NOP test (where in some examples, just the comparison test is executed) which optimizes both concrete sub-classes A and B in the hierarchy rooted at X. This is more efficient than doing two explicit tests (one each for A and B). That is, the NOP test avoids generating comparison test instructions. Put yet another way, execution of a single comparison test and a single NOP test may increase the efficiency of compiled code that is generated by the JIT compiler. Instead, the JVM keeps track of a spot in the source code where it lays down a NOP instruction that is supposed to be patched at run time if some condition changes.

For example, in a case where there is a single non-abstract sub-class A of class X, the JVM may not need to test whether x.class is of type A, as that is the single possible option (there is no other class it could be, given that it was declared of type X). However, if a new sub-class B gets loaded in the future, then the JVM will patch (i.e., change) that code location where the NOP instruction was to convert it into an unconditional JUMP instruction instead. This JUMP instruction will branch to a fall-back path where some conservatively correct code will be executed for the program to stay functional in that case, e.g., execute a virtual call.

However, with a NOP test, if there was not a change in the future where a new sub-class B gets loaded, then it is more efficient to execute the NOP test than to execute the comparison test since it is a single (and sometimes no) instruction. In this example, the NOP test used has precedent in the JIT compiler since there are other scenarios in which a single code location can be patched on a “compound” condition (e.g., A and B are the only concrete sub-classes in hierarchy rooted at X) in the corresponding run time assumption. All the compiler has to do is detect any future loading of a class that subclasses X, A, or B in order to patch the code location at run time.

Using this system, method, and computer program product, instruction sets that are guarded by test type may be better optimized by propagating more refined type information across more of the JIT compiled code. As a particular example, if a code fragment has another call to methods using x, (e.g., x.goo( )), then those calls may be unconditionally inlined, assuming that the system knows the method being called. For example, A.goo may be inlined without any test (explicit or NOP) if it is known that x was known to be of type A.

The system, method, and computer program product improve the functionality of a computing device. For example, as the computing device does not have to execute two comparison tests (e.g., one to test whether x is of the sub-class A and a second to test whether x is of the sub-class B), the overall size of the instruction set is smaller, thus resulting in reduced storage space on a memory device. That is, computing devices have a finite amount of storage space, and instruction sets take up storage space. By providing an instruction set that takes up less memory resources of the memory device, more space on the memory device is preserved for other instruction sets.

Moreover, as the instruction set is smaller on account of replacing a second comparison test with a NOP test, the processor performance is increased 1) by increasing processor bandwidth and 2) increasing processor throughput. That is, with less instructions to execute, the determination of the sub-class type of an unknown variable is performed more quickly such that other operations may be performed at the same time.

Still further, as described above NOP tests have previously been unusable when there are more than one sub-classes rooted at X. Accordingly, the present specification describes a system that utilizes a NOP test in a novel way. Specifically, to determine to which of two sub-classes an unknown variable pertains.

As yet another example, the processor may automatically address and resolve any potential issues in the instruction set more efficiently. Specifically, as the overall code length is reduced, there are less bugs to fix, and a processor may evaluate the instruction set more quickly.

Thus, the present method, systems, and computer program product provide an improvement to the computing device by 1) utilizing a NOP test to determine a sub-class type when there are more than one compile-time generated sub-classes, which has previously been unavailable and 2) conserves memory and processing resources by avoiding multiple explicit comparison tests to determine whether an unknown object is one of two identified sub-classes. Note that some embodiments may not have these potential advantages and these potential advantages are not necessarily required of all embodiments.

As used in the present specification and in the appended claims, the term “a number of” or similar language is meant to be understood broadly as any positive number including 1 to infinity.

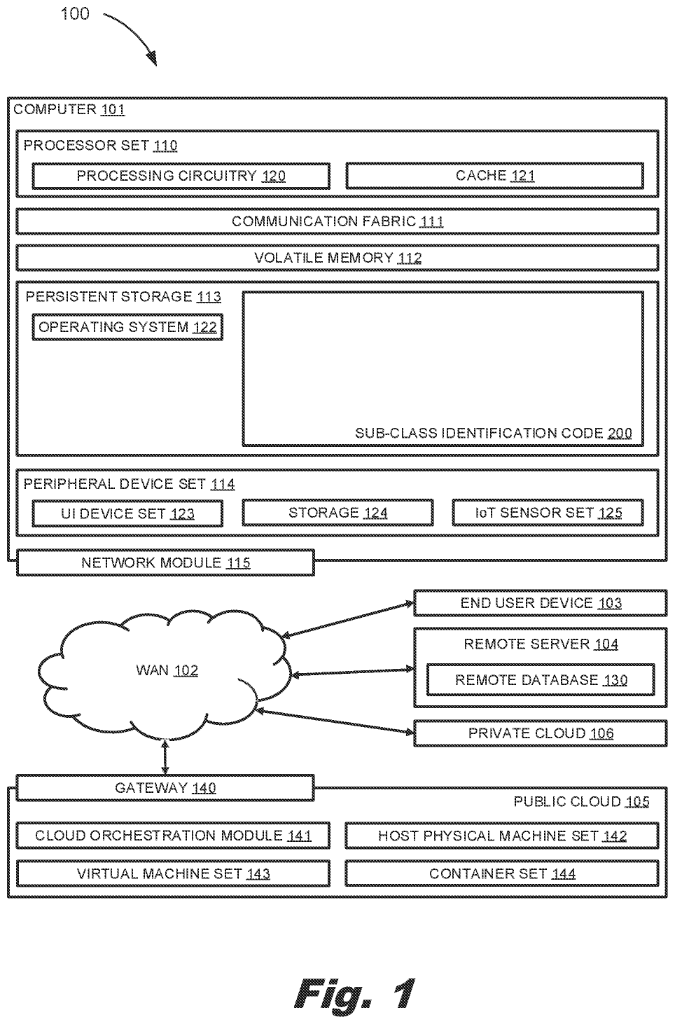

Turning now to the figures, FIG. 1 depicts a computing environment 100 for the execution of unknown object sub-class identification, according to an example of the principles described herein.

Computing environment 100 contains an example of an environment for the execution of at least some of the computer code involved in performing the inventive methods, such as sub-class identification code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

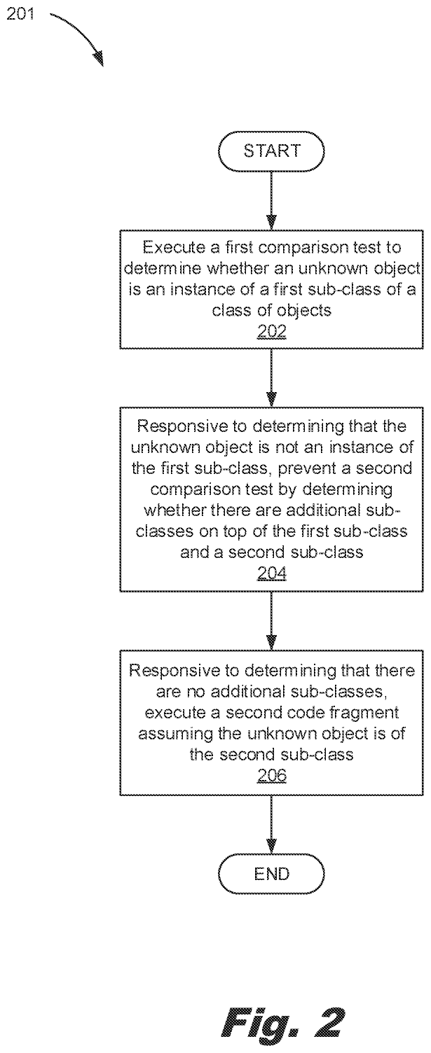

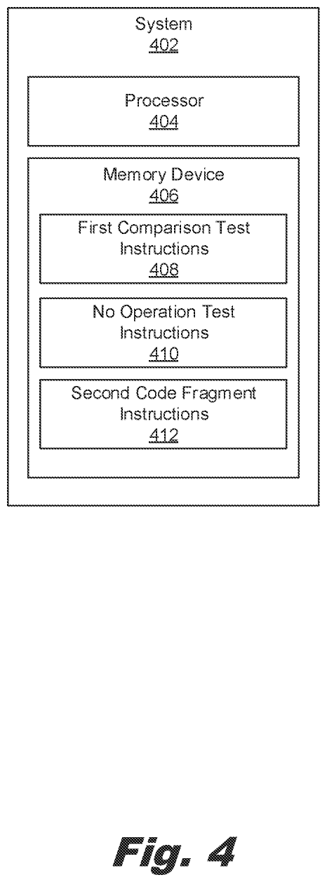

FIG. 2 depicts a computer-implemented method 201 for identifying unknown object sub-classes, according to an example of the principles described herein. As described above, the present specification describes a computer-implemented method 201 that is usable when there are at least two concrete sub-classes of a class and 1) prevents execution of two comparison tests to determine a sub-class of an unknown object and 2) facilitates use of a NOP test to determine to which of the two sub-classes an unknown object pertains, which is a novel feature. That is, NOP tests have previously been inoperable when there are two possible sub-classes for an unknown object. It should be noted that the operations depicted in the computer-implemented method 201 may be executed by the processing circuitry 120 depicted in FIG. 1 or the processor depicted in FIG. 4.

According to the computer-implemented method 201, the processing circuitry 120 and/or processor may execute (block 202) a first comparison test to determine whether an unknown object, x, is an instance of a first sub-class, A, of a class, X, of objects. Such a comparison test is an explicit test which compares the unknown object x, and its characteristics, against the characteristics of the first sub-class, A. If the first sub-class A and the unknown object x have the same characteristics and properties, or a threshold amount of the same characteristics and properties, the processor may determine that the unknown object is of the first sub-class type. There are various types of explicit comparison tests that may be executed to make such a determination. In an example, the processor determines that the unknown object is an instance of the first sub-class by executing an “instanceof” test which tests whether the unknown object is an instance of the first sub-class. In another example, the processor determines that the unknown object is an instance of the first sub-class by executing a type test added by a JIT manager. For example, the processor may evaluate “if (x.class==A).” Based on the outcome of the first comparison test, the processor may execute a variety of operations.

For example, responsive to determining that the unknown object is an instance of the first sub-class, the processor may execute a first code fragment which assumes that the unknown object is an instance of the first sub-class. In the example described above, C1 refers to a code fragment that is executed if the unknown object is known to be of first sub-class type in the original code. In this example, no second comparison test is executed as the sub-class type of the unknown object has been determined.

However, as there are two sub-classes that the unknown object may pertain to (e.g., sub-class A and sub-class B), it may be the case that the unknown object is not an instance of the first sub-class. In this example, responsive to determining that the unknown object is not an instance of the first sub-class, the processor may prevent (block 204) a second comparison test to determine the sub-class of the unknown object. That is, without the method as described herein, a processor may execute a second comparison test, (i.e., a second instanceof test or a second “if (x.class=B)” test to determine whether the unknown object pertains to a second sub-class B. Such a second comparison test takes up space on the memory device and is computationally expensive to execute as compared to when no such test is executed. Accordingly, the present computer-implemented method 201 prevents (block 204) the execution of a second comparison test, specifically by determining whether there are additional sub-classes other than the first sub-class and the second sub-class. That is, based on the first comparison test, the processor evaluates whether the unknown object is of the first sub-class. If the processor determines that the unknown object is of the first sub-class, the processor has successfully identified the sub-class of the unknown object. If the processor determines that the unknown object is not of the first sub-class, then the processor determines if there are just two concrete sub-classes. If there are just two concrete sub-classes in the original code, and the unknown object is not the first sub-class, the processor may identify the unknown object as pertaining to the second sub-class.

As such, responsive to determining that there are no additional sub-classes other than the first sub-class and the second sub-class, the processor may execute (block 206) a second code fragment which assumes the unknown object is an instance of the second sub-class. In the example described above, C2 refers to a code fragment that is executed if the unknown object is known to be of a second sub-class type in the original code. In this example, no second comparison test is executed as the sub-class type of the unknown object was first determined not to be sub-class A and the processor determined that A and B were the sub-classes without executing a second comparison test.

In the case that the processor determines that there are additional sub-classes on top of the first sub-class and the second sub-class, the processor may execute the second code fragment, or another code fragment, which refrains from assuming the unknown object is an instance of any particular sub-class. For example, the processor may execute a code fragment that is executed when the sub-class type of the unknown object is unknown. For example, upon generation of the source code, it may be the case that there are three sub-classes A, B, and C. In this example, once it is determined that the unknown object is not an instance of sub-class A and that there are additional sub-classes (e.g., sub-class C) in addition to sub-classes A and B, the processor may execute some other code fragment that does not assume the sub-class of the unknown object.

Example pseudocode is provided below which depicts the prevention of a second comparison test and which relies on a NOP test to determine to which of sub-classes A and B the unknown object x pertains. In a first example:

if (x instanceof A)
{
... code fragment C1 that assumes x is an instance of A
}
else
{
if (NOPed test that A and B are the only concrete sub-class in hierarchy
rooted at X)
{
... code fragment C2 that assumes x is an instance of B
}
else
{
...code fragment C2 that does not assume any sub-class for x
}

For a second example:

if (x.class == A)
{
... inlined code C3 for A.foo that assumes x is an instance of A
}
else
{
if (NOPed test that A and B are the only concrete sub-class in hierarchy
rooted at X)
{
direct call B.foo
}
else
{
...virtual call x.foo
}

In the example code presented above, determining (block 204) whether there are additional sub-classes for the class of objects in addition to the first sub-class and the second sub-class is performed by executing a NOP test, which does not consume memory space and which is more effective to use than an explicit comparison test. As such, the implementation of a NOP test conserves memory storage space, provides more processing bandwidth, and results in higher throughput as a NOP test is performed more quickly than a second comparison test. Moreover, the code and method 201 described above implement a NOP test in a two sub-class environment, which is novel.

Note that in the second example, executing the first code fragment comprises inlining the first code fragment as an instance of a function using the first sub-class assuming that the unknown object is an instance of the first sub-class and that executing the second code fragment comprises executing a virtual call to an instance of a function using the unknown object. However, other ways of executing the first and/or second code fragments may be implemented. For example, executing the first code fragment may include executing a virtual call to an instance of a function using the unknown object and executing the second code fragment may include inlining the second code fragment as an instance of a function using the second sub-class assuming that the unknown object is an instance of the second sub-class or refraining from assuming a sub-class that is associated with the unknown object. That is, in the second example the first and/or second code fragments may be inlined, directly called, or virtually called as desired.

In a particular example, the computer-implemented method 201 may be executed by a processor of a java virtual machine (JVM) of a java development kit (JDK). In this example, the processor or processing circuitry 120 may also form part of the JVM of the JDK. In an even more particular example, the processor forms part of a just-in-time (JIT) compiler. In this example, the code fragments, unknown objects, classes, and sub-classes are defined in a .class file.

Using this computer-implemented method 201, the functionality of a computing device in which is implemented is improved. For example, as the computing device does not have to execute two comparison tests (e.g., one to test whether x is of the sub-class A and a second to test whether x is of the sub-class B), the overall size of the instruction set is smaller, thus resulting in reduced storage space on a memory device. Moreover, as the instruction set is smaller on account of replacing a second comparison test with a NOP test, the processor execution is made more efficient and takes less time to run, thus creating more processing bandwidth than would otherwise be possible and increasing throughput.

Moreover, as described above NOP tests have previously been inoperable when there are more than one sub-classes rooted at X. Accordingly, the present specification describes a system that utilizes a NOP test in a novel way. As yet another example, the processor may automatically address and resolve any bug in the instruction set more efficiently.

Thus, the present method 201 provides an improvement to the computing device by 1) utilizing a NOP test to determine a sub-class type when there are more than one compile-time generated sub-classes, which has previously been unavailable and 2) conserves memory and processing resources by avoiding multiple explicit comparison tests to determine whether an unknown object is one of two identified sub-classes. Note that some embodiments may not have these potential advantages and these potential advantages are not necessarily required of all embodiments.

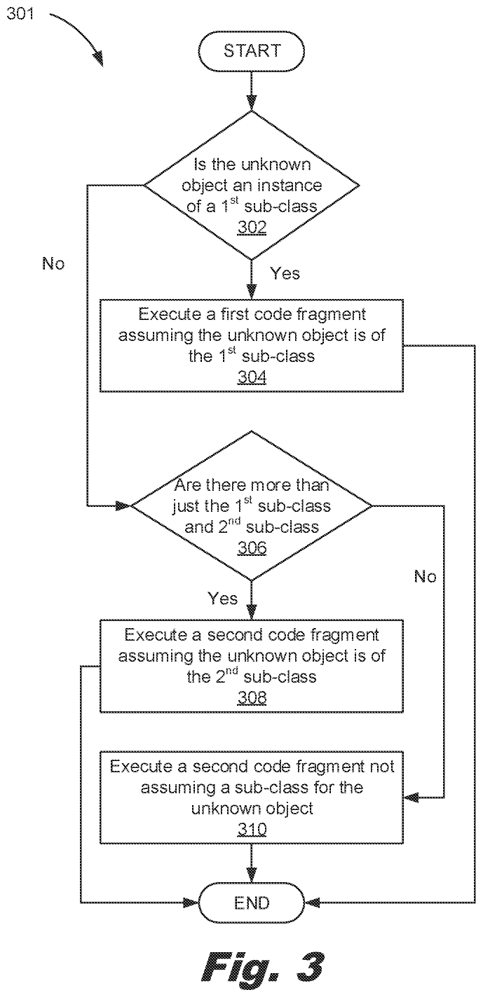

FIG. 3 depicts a computer-implemented method 301 for identifying unknown object sub-classes, according to an example of the principles described herein. According to the computer-implemented method 301, the processing circuitry 120 and/or processor determines (block 302) whether the unknown object is an instance of the first sub-class, which may be performed as described above. Responsive to determining that the unknown object is an instance of the first sub-class (block 302, determination YES) the processor may execute (block 304) a first code fragment which assumes that the unknown object is an instance of the first sub-class as described above. In the example described above, C1 refers to a code fragment that is executed if the unknown object is known to be of first sub-class type in the original code. In this example, no second comparison test is executed as the sub-class type of the unknown object has been determined.

Responsive to determining that the unknown object is not an instance of the first sub-class (block 302, determination NO), the processor may determine (block 306) whether there are additional sub-classes in addition to the first sub-class and the second sub-class. As described above, this determination may be made by executing a NOP test or performing some other operation.

Responsive to determining that there are no additional sub-classes other than the first sub-class and the second sub-class (block 306, determination YES), the processor may execute (block 308) a second code fragment which assumes the unknown object is an instance of the second sub-class. In the case that the processor determines that there are additional sub-classes on top of the first sub-class and the second sub-class (block 306, determination NO), the processor executes (block 310) the second code fragment, or another code fragment, which refrains from assuming the unknown object is an instance of any particular sub-class. For example, upon generation of the source code, it may be the case that there are three sub-classes A, B, and C. In this example, once it is determined that the unknown object is not an instance of sub-class A and that there are additional sub-classes (e.g., sub-class C) in addition to sub-classes A and B, the processor may execute some other code fragment that does not assume the sub-class of the unknown object. That is not to say that the unknown object does not have a sub-class type, rather the processor executes a code fragment that is not dependent upon a sub-class type.

Thus, the present method 301 provides an improvement to the computing device by 1) utilizing a NOP test to determine a sub-class type when there are more than one compile-time generated sub-classes, which has previously been unavailable and 2) conserves memory and processing resources by avoiding multiple explicit comparison tests to determine whether an unknown object is one of two identified sub-classes. Note that some embodiments may not have these potential advantages and these potential advantages are not necessarily required of all embodiments.

FIG. 4 depicts a system 402 for identifying unknown object sub-classes, according to an example of the principles described herein.

The system 402 may be implemented on any number of computing devices including desktop computers, laptop computers, mobile devices, servers, computing devices that rely on remote operating systems, and gaming systems among others. While particular reference is made to particular computing devices, the system 402 may be implemented as any number of computing devices with a processor 404 and a memory device 406.

That is, the system 402 includes a processor 404 and a memory device 406 communicatively coupled to the processor 404. The processor 404 includes the circuitry to retrieve executable code, i.e., instructions, from the memory device 406 and execute the executable code.

The memory device 406 may include a non-transitory storage medium. The memory device 406 may take many forms including volatile and non-volatile memory devices 406. For example, the memory device 406 may include Random-Access Memory (RAM), Read-Only Memory (ROM), optical memory disks, and magnetic disks, among others. The executable code may, when executed by the processor 404, cause the processor 404 to implement the functionality described herein. The memory device 406 may include a single memory element or multiple memory elements.

As described above, the memory device 406 includes instructions executable by the processor 404. The instructions are executable by the processor 404 to determine a sub-class of an unknown object in an instruction set. Specifically, the memory device 406 includes first comparison test instructions 408 to execute a first comparison test to determine whether an unknown object is an instance of a first sub-class of a class of objects. As described above, this first comparison test may be an instanceof test or a type test added by a JIT compiler.

The memory device 406 also includes no operation instructions 410 to, responsive to determining that the unknown object is not an instance of the first sub-class, prevent a second comparison test by performing a no operation (NOP) test to determine whether there are additional sub-classes on top of the first sub-class and the second sub-class. The memory device 406 also includes second code fragment instructions 412 to, responsive to determining that there are no additional sub-classes, execute the second code fragment which assumes the unknown object is an instance of the second sub-class. As described above, execution of the second code fragment may include inlining the second code fragment as an instance of a function using the second sub-class assuming that the unknown object is an instance of the second sub-class or executing a virtual call to an instance of a function using the unknown object.

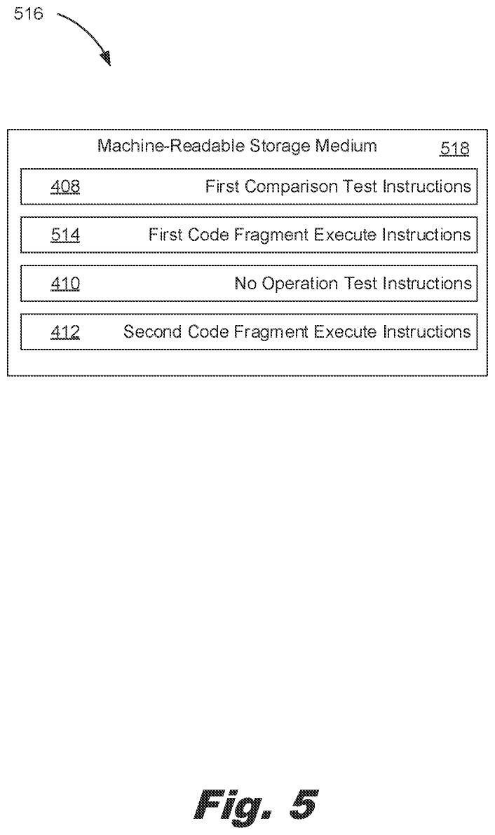

FIG. 5 depicts a computer program product 516 with a computer readable storage medium 518 for identifying unknown object sub-classes, according to an example of the principles described herein. To achieve its desired functionality, the system 402 includes various hardware components. Specifically, the system 402 includes a processor 404 and a machine-readable storage medium 518. The machine-readable storage medium 518 is communicatively coupled to the processor 404. The machine-readable storage medium 518 includes several instructions for performing a designated function. In some examples, the instructions may be machine code and/or script code.

The machine-readable storage medium 518 causes the processor 404 to execute the designated function of the instructions 408, 410, 412, 414. The machine-readable storage medium 518 can store data, programs, instructions, or any other machine-readable data that can be utilized to operate the system 402. Machine-readable storage medium 518 can store machine-readable instructions that the processor 404 of the system 402 can process or execute. The machine-readable storage medium 518 can be an electronic, magnetic, optical, or other physical storage device that contains or stores executable instructions. Machine-readable storage medium 518 may be, for example, Random-Access Memory (RAM), an Electrically Erasable Programmable Read-Only Memory (EEPROM), a storage device, an optical disc, etc. The machine-readable storage medium 518 may be a non-transitory machine-readable storage medium 518.

Referring to FIG. 5, first comparison test instructions 408, when executed by the processor 404, cause the processor 404 to execute a first comparison test to determine whether an unknown object is an instance of a first sub-class of a class of objects. First code fragment instructions 514, when executed by the processor 404, may cause the processor 404 to, responsive to determining that the unknown object is an instance of the first sub-class, execute a first code fragment which assumes the unknown object is an instance of the first sub-class. No operation test instructions 410, when executed by the processor 404, may cause the processor 404 to, responsive to determining that the unknown object is not an instance of the first sub-class, prevent a second comparison test by performing a no operation (NOP) test to determine whether there are additional sub-classes for the class of objects over the first sub-class and the second sub-class. Second code fragment instructions 412, when executed by the processor 404, may cause the processor 404 to, responsive to determining that there are no additional sub-classes, execute a second code fragment which assumes the unknown object is an instance of the second sub-class. The second code fragment instructions 412, when executed by the processor 404, may cause the processor 404 to, responsive to determining that there are additional sub-classes s, execute the second code fragment while refraining from assuming the unknown object is an instance of any particular sub-class.

What is claimed is:

1. A computer-implemented method, comprising:
executing, by a processor, a first comparison test to determine whether an unknown object is an instance of a first sub-class of a class of objects;
responsive to determining that the unknown object is not an instance of the first sub-class:
preventing, by the processor, a second comparison test to determine whether the unknown object is an instance of a second sub-class by determining whether there are additional sub-classes for the class of objects in addition to the first sub-class and the second sub-class; and
responsive to determining that there are no additional sub-classes, executing, by the processor, a second code fragment which assumes the unknown object is an instance of the second sub-class.

2. The computer-implemented method of claim 1, further comprising, responsive to determining that the unknown object is an instance of the first sub-class, executing, by the processor, a first code fragment which assumes the unknown object is an instance of the first sub-class.

3. The computer-implemented method of claim 2, wherein determining, by the processor, whether the unknown object is an instance of the first sub-class comprises executing an instanceof test.

4. The computer-implemented method of claim 2, wherein determining, by the processor, whether the unknown object is an instance of the first sub-class comprises executing a type test added by a just-in-time (JIT) compiler.

5. The computer-implemented method of claim 2, wherein executing the first code fragment comprises at least one of;
inlining the first code fragment as an instance of a function using the first sub-class assuming that the unknown object is an instance of the first sub-class; and.
executing a virtual call to an instance of a function using the unknown object.

6. The computer-implemented method of claim 1, further comprising, responsive to determining that there are additional sub-classes, executing, by the processor, the second code fragment which refrains from assuming the unknown object is of any particular sub-class.

7. The computer-implemented method of claim 1, wherein determining, by the processor, whether there are additional sub-classes comprises executing a no operation (NOP) test.

8. The computer-implemented method of claim 4, wherein executing the second code fragment comprises at least one of:
inlining the second code fragment as an instance of a function using the second sub-class assuming that the unknown object is an instance of the second sub-class; and
executing a virtual call to an instance of a function using the unknown object.

9. A system comprising:
a processor;
a memory device communicatively coupled to the processor, the memory device comprising instructions executable by the processor, the instructions comprising:
instructions to execute a first comparison test to determine whether an unknown object is an instance of a first sub-class of a class of objects;
responsive to determining that the unknown object is not an instance of the first sub-class:
instructions to prevent a second comparison test by performing a no operation (NOP) test to determine whether there are additional sub-classes for the class of objects in addition to the first sub-class and a second sub-class; and
instructions to, responsive to determining that there are no additional sub-classes, execute a second code fragment which assumes the unknown object is an instance of the second sub-class.

10. The system of claim 9, further comprising instructions executable by the processor to cause the processor to, responsive to determining that the unknown object is an instance of the first sub-class, execute a first code fragment which assumes the unknown object is an instance of the first sub-class.

11. The system of claim 9, further comprising instructions executable by the processor to cause the processor to, responsive to determining that there are additional sub-classes, execute the second code fragment which refrains from assuming the unknown object is of any particular sub-class.

12. The system of claim 9, wherein the processor forms part of a just-in-time (JIT) compiler.

13. The system of claim 9, wherein executing the second code fragment comprises inlining the second code fragment as an instance of a function using the second sub-class assuming that the unknown object is an instance of the second sub-class.

14. The system of claim 9, wherein executing the second code fragment comprises executing a virtual call to an instance of a function using the unknown object.

15. A computer program product, the computer program product comprising a computer readable storage medium having program instructions embodied therewith, the program instructions executable by a processor, to cause the processor to:
execute a first comparison test to determine whether an unknown object is an instance of a first sub-class of a class of objects;
responsive to determining that the unknown object is not an instance of the first sub-class:
prevent a second comparison test by performing a no operation (NOP) test to determine whether there are additional sub-classes for the class of objects in addition to the first sub-class and a second sub-class; and
responsive to determining that there are no additional sub-classes, execute a second code fragment which assumes the unknown object is an instance of the second sub-class.

16. The computer program product of claim 15, further comprising instructions executable by the processor to cause the processor to, responsive to determining that the unknown object is an instance of the first sub-class, execute a first code fragment which assumes the unknown object is an instance of the first sub-class.

17. The computer program product of claim 15, further comprising instructions executable by the processor to cause the processor to, responsive to determining that there are additional sub-classes, execute the second code fragment which refrains from assuming the unknown object is of any particular sub-class.

18. The computer program product of claim 15, wherein the instructions are executed within a java virtual machine (JVM) of a java development kit (JDK).

19. The computer program product of claim 15, wherein the code fragments, unknown objects, and classes are defined in a .class file.

20. The computer program product of claim 15, wherein the processor forms part of a just-in-time (JIT) compiler.
